(19) United States
(12) Patent Application Publication
(10) Pub. No.: US 2006/0259543 A1
(43) Pub. Date: Nov. 16, 2006

(54) Method and filtering text messages in a communication device

(76) Inventor: Paul Geoffrey Tindall, Bedfordshire (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/540,532

(22) PCT Filed: Oct. 6, 2003
(86) PCT No.: PCT/GB03/04292

§ 371 Date: Jun. 24, 2005

(51) Int. Cl. G06F 15/16

(52) U.S. Cl. 709/203; 713/153; 709/217

(57) ABSTRACT

A method of filtering messages received by a telecommunications device comprises inputting a rule set into the telecommunications device, and then reading an incoming message. The message is then modified if that message breaks a rule of the rule set; and the modified message is displayed. The rule set comprises a plurality of rules, each of which relates to a respective predetermined message content.

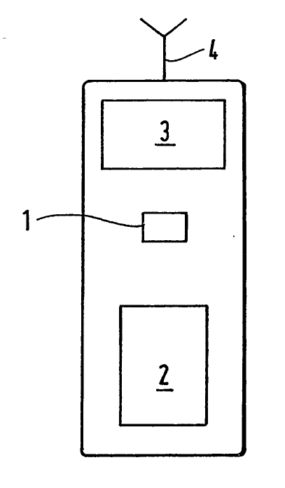

This invention relates to a method of filtering messages received by a telecommunications device such as a mobile phone, and in particular to a method of filtering the content of text messages to remove or modify text that may be offensive to the user of the device.

An increasingly important feature of modern mobile phones is the ability to send SMS messages (text messages). Mobile text messaging has become very popular, particularly for the young. Usually, the receiver of a text message knows the sender of that message, but many messages are unsolicited, for the purposes of, for example, advertising. There is a growing concern that the content of some messages, either solicited or unsolicited, may cause offence to the recipient, and it is impossible for the recipient to know whether a message is likely to cause offence without displaying and reading it.

Mobile network operators have some responsibility to prevent such messages being delivered, and are investing in server technology to filter text messages, so that they don't end up on users' mobile phones. However, because the number of messages being past through each network is very large, it requires powerful machines to process all of them reliably. One way in which a mobile network operator can filter text messages is to apply a generic set of rules for the filtering of likely offensive material (such as profanity, racism etc). These rules do, however, tend to be general, as they must relate to material which is likely to be deemed offensive by the majority of users.

The aim of the invention is to provide a method of filtering messages to remove offensive material in such a way that a recipient can tailor the filtering rules so as to remove or modify the content of received messages that is offensive to that user.

The present invention provides a method of filtering messages received by a telecommunications device, the method comprising the steps of:—
a) inputting a rule set into the telecommunications device;
b) reading an incoming message;
c) modifying the message if that message breaks a rule of the rule set; and
d) displaying the modified message;

wherein the rule set comprises a plurality of rules, each of which relates to a respective predetermined message content.

In a preferred embodiment, the message is a text message. In this case, step b) may include the step of parsing the incoming test message, and step c) may be such as to delete the predetermined text content, or to replace the letters of the predetermined text content with meaningless characters.

Preferably, step a) is carried out by downloading the rule set from a network operator.

Advantageously, the method further comprises the step of modifying the rule set, by the user of a telecommunications device, to accommodate the needs of that user.

The invention also provides a telecommunications device comprising a transceiver, a processor and a display, the processor including software containing a rule set, means for reading an incoming message, means for modifying the message if that message breaks a rule of the rule set whereby a modified message is shown on the display, wherein the rule set comprises a plurality of rules, each of which relates to a respective predetermined message content.

Preferably, the software is such that a user of the device can modify the rule set.

In a preferred embodiment, the device further comprises data input means linked to the processor for modifying the rule set. Conveniently, a keypad constitutes the data input means.

Where the message is a text message, the software may be such as to parse the incoming text message, and such as to delete the predetermined text content, or to replace letters of the predetermined text content with meaningless characters.

The invention will now be described in greater detail, by way of example, with reference to the drawing, the single FIGURE of which is a schematic representation of a mobile phone.

Referring to the drawing, a mobile phone includes a processor 1, a keypad 2, a display 3 and an antenna 4. The keypad 2 can be used, in known manner, to input text messages for processing by the processor 1 and transmitting via the antenna 4, to the mobile phones of other users. Text messages received from other users via the antenna 4 are processed by the processor 1 and shown on the display 3.

In order to carry out the invention, a rule set is input into the processor 1. The inputting of the rule set can be carried out prior to the purchase of the mobile phone, or can be downloaded from a network operator via the antenna 4. In either case, the rule set can be modified to comply with the individual needs of the user of the mobile phone, the operator of the mobile network, or even by particular local requirements. For example, there may be local requirements for content filtering based on both the fashion of the day and the geographical location. In particular, new vernacular words, specifically those which might cause offence, enter and leave the language regularly, due to the fact that language is ever changing. In addition, some words and phrases only have an offensive meaning in certain geographical locations (for example the word “fag” is offensive in the USA, but not in the UK). The mobile network operator may also be provided with a facility for pre-storing the rule set, for downloading the rule set, and/or permitting the user to edit the rule set on the mobile phone.

The rule set will be an algorithm which will first parse each incoming text message, and then each rule will, in turn, read the parsed text content to determine whether or not that particular rule has been violated. For example, one rule may search for a given rude word, other rules may search for other rude words, and yet other rules may search for particular words or phrases of a racist character. The rule set is such that, if a given rule is violated, the software (the algorithm) will then process the message in accordance with that rule, for example, by deleting the text content which violates the rule, or by modifying that text content, for example, or by replacing the text letters with meaningless characters such as asterisks. Thus, each rule may have different modifying actions for given degrees of offensiveness. In particular, if the rule is to look for one of a given list of “four letter” words, the user could modify the basic rule set originally input into the processor 1, so as to vary the actions carried out in dependence upon how that user rates the offensiveness of the various words in the list. In this case for text content which is deemed least offensive by the user, the rule set may be such as to allow that content to be displayed.

It will be apparent that modifications could be made to the invention as described above with reference to the drawing. In particular, data input can be carried out by any suitable means, and is not restricted to the use of the keypad 2. For example, data could be input into the mobile phone 1 by downloading from a PC, or by utilising speech recognition software. In this connection, data input covers both the inputting of text messages and any modification of the rule set contained in the mobile phone 1. It will also be apparent that the invention is not restricted to the filtering of messages received by mobile phones, and is also applicable to other devices such as personal digital assistants (PDAs) and wireless gaming devices. Moreover, the invention is equally applicable to the filtering of other forms of messages received by communications devices such as mobile phones, and is not restricted to the filtering of the content of text messages.

1. A method of filtering text messages received by a mobile telecommunications device, the method comprising the steps of:
a) inputting a rule set into the telecommunications device by downloading the rules set from a network operator;
b) reading an incoming message;
c) modifying the message if that message breaks a rule of the rule set; and
d) displaying the modified message;
wherein the rule set comprises a plurality of rules, each of which relates to a respective predetermined message content.

2. A method as claimed in claim 1, wherein the message is a text message.

3. A method as claimed in claim 2, wherein step b) includes the step of parsing the incoming test message.

4. A method as claimed in claim 2 or claim 3, wherein step c) is such as to delete the predetermined text content, or to replace the letters of the predetermined text content with meaningless characters.

5. A method as claimed in any one of claims 1 to 3, wherein step a) is carried out by downloading the rule set from a network operator.

6. A method of filtering text messages received by a mobile telecommunications device, the method comprising the steps of:
a) inputting a rule set into the telecommunications device;
b) reading an incoming message;
c) modifying the message if that message breaks a rule of the rule set;
d) displaying the modified message; and
e) modifying the rule set, to accommodate the needs of a user, by that user inputting a modification to the rule set;
wherein the rule set comprises a plurality of rules, each of which relates to a respective predetermined message content.

7. A telecommunications device comprising a transceiver, a processor and a display, the processor including software, means for inputting a rule set into the software from a network operator, means for reading an incoming message, means for modifying the message if that message breaks a rule of the rule set whereby a modified message is displayed, wherein the rule set comprises a plurality of rules, each of which relates to a respective predetermined message content.

8. A device as claimed in claim 7, wherein the software is such that a user of the device can modify the rule set.

9. A device as claimed in claim 8, further comprising data input means linked to the processor for modifying the rule set.

10. A device as claimed in claim 9, wherein a keypad constitutes the data input means.

11. A device as claimed in any one of claims 7 to 10, wherein, when the message is a text message, the software is such as to parse the incoming text message.

12. A device as claimed in claim 11, wherein the software is such as to delete the predetermined text content, or to replace letters of the predetermined text content with meaningless characters.

13. A mobile telecommunications device comprising a transceiver, a processor and a display, the processor including software containing a rule set, means for modifying the rule set, to accommodate the needs of a user, on input of a modification of the rule set by that user, means for reading an incoming message, means for modifying the message if that message breaks a rule of the rule set whereby a modified message is displayed, wherein the rule set comprises a plurality of rules, each of which relates to a respective predetermined message content.
